(19) United States
(12) Patent Application Publication
(10) Pub. No.: US 2017/0362488 A1
(43) Pub. Date: Dec. 21, 2017

(54) Dry Products for Wellbore Fluids and Methods of Use Thereof

(71) Applicant: M-I DRILLING FLUIDS UK LTD, Aberdeen (GB)

(72) Inventors: Steven Philip Young, Cypress, TX (US); James Stark, Spring, TX (US); Lijein Lee, Sugar Land, TX (US)

(21) Appl. No.: 15/532,489

(22) PCT Filed: Dec. 4, 2015
(86) PCT No.: PCT/US2015/063882

§ 371 Date: Jun. 1, 2017

Related U.S. Application Data
(60) Provisional application No. 62/087,540, filed on Dec. 4, 2014.

(51) Int. Cl. C09K 8/28; B01D 33/03; C09K 8/035; E21B 21/06

(52) U.S. Cl. CPC C09K 8/28; E21B 21/065; B01D 33/0346; C09K 8/035

(57) ABSTRACT

A method may include adding a dry carrier powder loaded with a liquid additive into a wellbore fluid, thereby releasing at least a portion of the liquid additive into the wellbore fluid; and pumping the wellbore fluid with the liquid additive therein into a wellbore.

### CROSS REFERENCE TO RELATED APPLICATION

The present application claims the benefit of, and priority to, U.S. Provisional Patent Application No. 62/087540, filed Dec. 4, 2014, which is hereby incorporated by reference in its entirety.

### BACKGROUND

When drilling or completing wells in earth formations, various fluids typically are used in the well for a variety of reasons. Common uses for well fluids include: lubrication and cooling of drill bit cutting surfaces while drilling generally or drilling-in (i.e., drilling in a targeted petroliferous formation), transportation of “cuttings” (pieces of formation dislodged by the cutting action of the teeth on a drill bit) to the surface, controlling formation fluid pressure to prevent blowouts, maintaining well stability, suspending solids in the well, minimizing fluid loss into and stabilizing the formation through which the well is being drilled, fracturing the formation in the vicinity of the well, displacing the fluid within the well with another fluid, cleaning the well, testing the well, transmitting hydraulic horsepower to the drill bit, fluid used for emplacing a packer, abandoning the well or preparing the well for abandonment, and otherwise treating the well or the formation.

In most rotary drilling procedures the drilling fluid takes the form of a “mud,” i.e., a liquid having solids suspended therein. The solids function to impart desired rheological properties to the drilling fluid and also to increase the density thereof in order to provide a suitable hydrostatic pressure at the bottom of the well. Fluid compositions may be water-or oil-based and may comprise weighting agents, surfactants, emulsifiers, viscosifiers, wetting agents, rheology modifiers, etc. in order to arrive at the desired fluid properties.

Drilling fluids are generally characterized as thixotropic fluid systems. That is, they exhibit low viscosity when sheared, such as when in circulation (as occurs during pumping or contact with the moving drilling bit). However, when the shearing action is halted, the fluid should be capable of suspending the solids it contains to prevent gravity separation. In addition, when the drilling fluid is under shear conditions and a free-flowing near-liquid, it must retain a sufficiently high enough viscosity to carry all unwanted particulate matter from the bottom of the well bore to the surface. The drilling fluid formulation should also allow the cuttings and other unwanted particulate material to be removed or otherwise settle out from the liquid fraction.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method that includes adding a dry carrier powder loaded with a liquid additive into a wellbore fluid, thereby releasing at least a portion of the liquid additive into the wellbore fluid; and pumping the wellbore fluid with the liquid additive therein into a wellbore.

In another aspect, embodiments disclosed herein relate to a method that includes circulating a wellbore fluid comprising a base fluid and a dry carrier loaded with a liquid additive through a wellbore while drilling; collecting the circulated wellbore fluid at the surface, the circulated wellbore fluid comprising the base fluid, liquid additive released into the base fluid from the dry carrier, and the dry carrier; removing at least a portion of the dry carrier from the circulated wellbore fluid to form a separated wellbore fluid comprising the base fluid and the liquid additive released into the base fluid; and re-circulating the separated wellbore fluid through the wellbore.

Other aspects and advantages of the claimed subject matter will be apparent from the following description and the appended claims.

### DETAILED DESCRIPTION

In one aspect, embodiments disclosed herein relate to wellbore fluid additives provided in a dry form. Specifically, embodiments disclosure herein relate to the use of a dry carrier for liquid wellbore fluid additives so that health, safety, and environmental issues that arise from handling of liquid additives can be reduced. Thus, the fluid is mixed/formulated, for example, at the rig surface by mixing the dry additives (e.g., liquid additives adsorbed or absorbed into a dry carrier) with other fluid components, and the liquid additives may be released into the fluid, without the dry carrier significantly impacting the fluid rheological profile.

In one or more embodiments, the dry carrier may be a solid powder that carrying capacity of at least 40 volume per mass percent, while still remaining as a flowable powder while carrying the liquid additives. In other embodiments, the carrying capacity may be at least 50, 60, or 65 volume per mass percent and up to 75 volume per mass percent. Further, the liquid should be released into the wellbore fluid upon mixing, and in embodiments, at least 50, 60, 70, or 80% of the liquid adsorbed or absorbed into the carrier may be released into the wellbore fluid. Such dry carriers may include, for example, silica, lime, clays, salt with soda ash, activated carbon, calcium carbonate, barite, zeolites, vermiculite, and ceramics (including materials conventionally used as proppants in fracturing operations). Optionally, after the fluid is formulated and the liquid additive is released from the dry carrier, at least a portion of the dry carrier may be removed from the wellbore fluid.

In embodiments, the dry carrier may have a d₅₀ particle size ranging, for example, from about 5 to 500 microns, and may have a lower limit of any of 5, 10, 50, or 100 microns, and an upper limit of any of 500, 300, 250, or 150 microns, where any lower limit may be used in combination with any upper limit. Depending on the liquid loading onto the dry carrier, the particular size range may be selected so that combined powder carrying the liquid remains flowable, while maximizing (if desired) the carrying capacity. That is, generally, smaller particles may have a greater carrying capacity (due to greater porosity and/or surface area); however, smaller particles may have less flowability. Further, in one or more embodiments, the selection of the particle size may also be based, for example, on the removal of the dry carrier from the wellbore fluid, after the release of the liquid additive(s) into the wellbore fluid.

As mentioned above, the dry carrier may optionally be removed from the wellbore fluid after formulation/mixing of the fluid. In some embodiments, the dry carrier may be removed prior to the fluid being circulated into the wellbore, but in other embodiments, the dry carrier may be removed after the fluid has circulated through the wellbore, such as by screening the wellbore fluid through a vibratory separator. That is, depending on the particle size of the dry carrier selected, the dry carrier may be screened out of the fluid prior to recirculation of the fluid into the wellbore during the solids control screening process conventionally used in the fluid circulation process. Vibratory separators (conventionally referred to as shale shakers in the oil and gas industry) are used to separate solid particulates of different sizes and/or to separate solid particulate from fluids. Shale shakers or vibratory separators are used to remove cuttings and other solid particulates from wellbore fluids returned from a wellbore. A shale shaker is a vibrating sieve-like table upon which returning used wellbore fluid is deposited and through which substantially cleaner fluid emerges. The shale shaker may be an angled table with a generally perforated filter screen bottom. Returning wellbore fluid is deposited at one end of the shale shaker. As the wellbore fluid travels toward the opposite end, the fluid falls through the perforations to a reservoir below, thereby leaving the solid particulate material behind. Thus, depending on the mesh of the screen and the particle size of the dry carrier, in particular embodiments, the wellbore fluid containing the dry carrier (and released liquid additives) may be deposited at one end of the shale shaker, and as the fluid travels toward the opposite end, the dry carrier (without at least a portion of the liquid additives) may remain on the screen surface while the fluid falls to a reservoir below and may be recirculated into the wellbore for further wellbore operations. However, it is envisioned that other separatory mechanisms may be used to separate the dry carrier from the wellbore fluid, if desired. If, however, a shale shaker is used, advantageously, the dry carrier may be removed during the course of a conventional screening process used to remove drill cuttings from the fluid by selecting the appropriate screen mesh depending on the dry carrier particle size.

As mentioned above, the dry carriers of the present disclosure may carry one or more liquid additives for addition to the wellbore fluid. There is no limitation on the type of additives that may be provided by the dry carrier, but examples of types of such additives that are envisioned include wetting agents, thinners, rheology modifiers, emulsifiers, surfactants, dispersants, interfacial tension reducers, pH buffers, mutual solvents, lubricants, defoamers, cleaning agents, corrosion inhibitors, scavengers, chelating agents, and biocides. In embodiments, the incorporation of such components may be at an amount up to 8 pounds per barrel (“ppb”) (30.4 g/liter) (which includes the liquid additive and dry carrier), or at least 1 ppb (3.8 g/liter), 2 ppb (7.6 g/liter), or 4 ppb (15.2 g/liter) in other embodiment. Other amounts may be used depending on the application and rheological profile (and the impact of the dry carrier on the rheological profile). In one or more embodiments, the dry carrier has a less than 20% change on one or more rheological properties of the fluid, and less than 15 or 10% change on one or more rheological properties in other embodiments.

Further, in some embodiments, such amounts are the cumulative amount of liquid additives provided by the dry carrier, whether it includes one type of additive, or a plurality of additives. When a plurality of fluid additives are used, it is envisioned that each additive may be separately adsorbed/absorbed into dry carrier powder, or a mixture of additives may be adsorbed/absorbed into dry carrier. In other embodiments, additives may be separately adsorbed/absorbed, and the loaded carrier powder may be subsequently mixed together. When separately adsorbed/absorbed into the powder and the loaded powders are not mixed together, the loaded carriers can be sequentially or simultaneously added to the wellbore fluid.

The fluids disclosed herein are especially useful in the drilling, completion, working over, and fracturing of subterranean oil and gas wells. In particular, the fluids disclosed herein may find use in formulating drilling muds and completion fluids; however, it is envisioned that the dry carriers loaded with liquid additives may be used to formulate any type of wellbore fluid.

In one or more embodiments, loading of liquid additive into the carrier may be achieved by adding liquid additive to the dry carrier and mixing until the desired loading is desired. Such mixing may be achieved using any type of mixer, such as a shear mixer or dynamic mixer. While mixing the carrier and liquid additive, the loading amount may be balanced by the powder to remain flowable after loading.

Use of a flowable powder carrying the liquid additive may allow for the liquid additives to be transported in bags or the like, instead of in steel drums. A free-flowing powder may be added to a wellbore fluid, for example, through a feed hopper. Upon addition to the base fluid of a wellbore fluid, other non-liquid or other liquid additives (not loaded onto a dry carrier) may also be added. The components may be added in the order in which they are conventionally added for wellbore fluid formulation/mixing.

Conventional methods can be used to prepare the wellbore fluids disclosed herein in a manner analogous to those normally used, to prepare conventional water-and oil-based wellbore fluids. In one embodiment, a desired quantity of water-based fluid and the components of the wellbore fluid added sequentially with continuous mixing. In another embodiment, a desired quantity of oleaginous fluid such as a base oil, a non-oleaginous fluid and the components of the wellbore fluid are added sequentially with continuous mixing. An invert emulsion may be formed by vigorously agitating, mixing or shearing the oleaginous fluid and the non-oleaginous fluid.

In one embodiment, upon addition of the loaded dry carrier into the fluid, the liquid additive carried thereon may be released into the fluid and the dry carrier may optionally be removed from the wellbore fluid, either before or during a wellbore operation. The timing of the removal of the carrier may depend, for example, on the type of operation in which the fluid is being used. For example, if the fluid is being used in a completion operation, where it is desirable for the fluid to be solids-free, then the dry carrier may be removed prior to being circulated in the well. On the other hand, if the fluid is being used during a drilling operation, then the dry carrier may be removed after an initial circulation through the wellbore, such as during the process in which the drill cuttings are removed from the fluid. In yet another example, if the fluid is being used during a fracturing operation, it may not be desirable to remove the dry carrier if it can also function as a proppant in the fracturing operation.

As mentioned above, the wellbore fluid additives of the present disclosure may be used in either water-based or oil-based wellbore fluids. Oil based fluids may include either an invert emulsion (water in oil) or a direct emulsion (oil in water).

Water-based wellbore fluids may have an aqueous fluid as the base solvent (continuous phase) and be substantially free of an emulsified or discontinuous phase. The aqueous fluid may include at least one of fresh water, sea water, brine, mixtures of water and water-soluble organic compounds and mixtures thereof. For example, the aqueous fluid may be formulated with mixtures of desired salts in fresh water. Such salts may include, but are not limited to alkali metal chlorides, hydroxides, or carboxylates, for example. In various embodiments of the drilling fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, sulfur, aluminum, magnesium, potassium, strontium, silicon, lithium, and phosphorus salts of chlorides, bromides, carbonates, iodides, chlorates, bromates, formates, nitrates, oxides, and fluorides. Salts that may be incorporated in a given brine include any one or more of those present in natural seawater or any other organic or inorganic dissolved salts. Additionally, brines that may be used in the drilling fluids disclosed herein may be natural or synthetic, with synthetic brines tending to be much simpler in constitution. In one embodiment, the density of the drilling fluid may be controlled by increasing the salt concentration in the brine (up to saturation). In a particular embodiment, a brine may include halide or carboxylate salts of mono-or divalent cations of metals, such as cesium, potassium, calcium, zinc, and/or sodium.

As mentioned above, in one or more embodiments, the wellbore fluid may be an invert emulsion. The oil-based/invert emulsion wellbore fluids may include an oleaginous continuous phase, a non-oleaginous discontinuous phase, and one or more additives. The oleaginous fluid may be a liquid and more preferably is a natural or synthetic oil and more preferably the oleaginous fluid is selected from the group including diesel oil; mineral oil; a synthetic oil, such as hydrogenated and unhydrogenated olefins including poly(alpha-olefins), linear and branch olefins and the like, polydiorganosiloxanes, siloxanes, or organosiloxanes, esters of fatty acids, specifically straight chain, branched and cyclical alkyl ethers of fatty acids, mixtures thereof and similar compounds known to one of skill in the art; and mixtures thereof. The concentration of the oleaginous fluid should be sufficient so that an invert emulsion forms and may be less than about 99% by volume of the invert emulsion. In one embodiment, the amount of oleaginous fluid is from about 30% to about 95% by volume and more preferably about 40% to about 90% by volume of the invert emulsion fluid. The oleaginous fluid, in one embodiment, may include at least 5% by volume of a material selected from the group including esters, ethers, acetals, dialkylcarbonates, hydrocarbons, and combinations thereof.

The non-oleaginous fluid used in the formulation of the invert emulsion fluid disclosed herein is a liquid and may be an aqueous liquid. In one embodiment, the non-oleaginous liquid may be selected from the group including sea water, a brine containing organic and/or inorganic dissolved salts, liquids containing water-miscible organic compounds and combinations thereof. The amount of the non-oleaginous fluid is typically less than the theoretical limit needed for forming an invert emulsion. Thus, in one embodiment, the amount of non-oleaginous fluid is less that about 70% by volume and preferably from about 1% to about 70% by volume. In another embodiment, the non-oleaginous fluid is preferably from about 5% to about 60% by volume of the invert emulsion fluid.

Other additives that may be included in the wellbore fluids disclosed herein include for example, weighting agents, organophilic clays, viscosifiers, and fluid loss control agents. Additionally, it is also envisioned that one or more of the additive types mentioned above can instead be provided in a liquid form directly to the fluid and need not be provided in a dry carrier.

### EXAMPLES

### Example 1

In order to verify the release of liquid additive, SUREWET™ (a wetting agent available from M-I SWACO (Houston, Tex.)) from a silica dry powder into a base oil, the acid number of various samples (a 2 g aliquot) was tested, as shown below in Table 1. The dry SUREWET™ is 66% active (2:1 V/g or 1.782:1 g/g). Based on this, 2.8 g of SUREWET™ would have a theoretical acid number of 21.5, which may be used to calculate the release (or recovery) of SUREWET™ into the base oil.

TABLE 1

| | Acid Number | |
|---|---|---|
| Sample | (mg KOH/g) | Recovery |
| Base oil—blank | 0.1 | — |
| Base oil with liquid SUREWET ™ | 20.7 | — |
| Base oil with dry SUREWET ™ | 17.6 | 81.8% |
| Base oil with dry version of SUREWET ™ | 14.0 | 65.11% |
| run across a 200 mesh screen, not shaken | | |
| Base oil with dry version of SUREWET ™ | 18.4 | 85.58% |
| run across a 200 mesh screen, shaken | | |

### Example 2

An invert emulsion (70:30 O/W) wellbore fluid was formulated with a rheology modifier (EMI-1005, available from M-I SWACO (Houston, Tex.)) loaded onto a silica powder (SIPERNAT® 22, available from Evonik Industries) at 50% active (vol/wt) in accordance with the present disclosure. The fluid also included VG PLUS™ (an amine treated bentonite), SUREMUL™ PLUS (an amidoamine emulsifier), ECOTROL™ (an oil soluble polymeric fluid loss control agent), MI WATE (a 4.1 SG barite), all of which are available from MI SWACO (Houston, Tex.), and OCMA (kaolinite) and a synthetic blend of olefins as the base oil. The fluids are formulated (with liquid and dried EMI-1005 rheology modifier) as shown in Table 2 below. The rheological properties were measured on a Fann 35 viscometer as shown in Table 3 below.

TABLE 2

| | Sample 1 | Sample 2 |
|---|---|---|
| Component | (Liquid Comparison) | (Dried) |
| Synthetic Base (g) | 142 | 142 |
| VG PLUS ™ (g) | 1 | 1 |
| Lime (g) | 3 | 3 |
| SUREMUL ™ PLUS (g) | 10 | 10 |
| ECOTROL ™ RD (g) | 0.5 | 0.5 |
| 25% CaCl2 brine (g) | 104 | 104 |
| MI WATE ™ (g) | 284 | 284 |
| EMI-1005 (g) | 0.6 | 1.2 |
| OCMA (g) | 25 | 25 |
| Mud Wt, ppg | 13.22 | 13.21 |

TABLE 3

| | Sample 1 | | | | | | | |
|---|---|---|---|---|---|---|---|---|
| | (Liquid Comparison) | | | | Sample 2 (Dried) | | | |
| | 150 | 40 | 100 | 150 | 150 | 40 | 100 | 150 |
| | F. | F. | F. | F. | F. | F. | F. | F. |
| 600 | 62 | 216 | 94 | 72 | 63 | 211 | 94 | 71 |
| 300 | 40 | 123 | 56 | 46 | 40 | 119 | 57 | 47 |
| 200 | 32 | 88 | 42 | 37 | 33 | 88 | 43 | 38 |
| 100 | 22 | 51 | 27 | 27 | 24 | 51 | 28 | 28 |
| 6 | 8 | 11 | 19 | 12 | 9 | 12 | 11 | 13 |
| 3 | 6 | 9 | 9 | 11 | 8 | 9 | 10 | 12 |
| PV | 22 | 93 | 38 | 26 | 23 | 92 | 37 | 24 |
| YP | 18 | 30 | 18 | 20 | 17 | 27 | 20 | 23 |
| 10″ Gels | 9 | 13 | 13 | 14 | 10 | 14 | 14 | 15 |
| ES | 610 | | | 550 | 636 | | | 625 |
| HTHP | | | | 4.6 | | | | 5.2 |
| 250 F. | | | | | | | | |

### Example 3

An invert emulsion (80:20 O/W) wellbore fluid was formulated with a rheology modifier (SUREMOD, available from M-I SWACO (Houston, Tex.)) loaded onto silica powder (described above) at 60% active (vol/wt), in accordance with the present disclosure. The fluid also included VG PLUS™ (an amine treated bentonite), ONEMUL™ PLUS (an amidoamine with added surfactant), MI WATE (a 4.1 SG barite), all of which are available from MI SWACO (Houston, Tex.), and low sulfur diesel #2 and OCMA (kaolinite). The fluids are formulated (with and without dried SUREMOD rheology modifier) as shown in Table 4 below. The rheological properties were measured on a Fann 35 viscometer as shown in Table 5 below.

TABLE 4

| Component | Sample 3 (blank) | Sample 4 (Dried) |
|---|---|---|
| Low S Diesel #2 (g) | 178 | 178 |
| VG PLUS ™ (g) | 4 | 4 |
| Lime (g) | 6 | 6 |
| ONE-MUL ™ (g) | 7 | 7 |
| 25% CaCl₂ (g) | 70.5 | 70.5 |
| MI WATE (g) | 280 | 280 |
| SURE-MOD (g) | — | 3 |
| OCMA Clay (g) | 30 | 30 |

TABLE 5

| Rheology | Sample 3 (blank) | | Sample 4 (Dried) | |
|---|---|---|---|---|
| at 150 F. | BHR | AHR | BHR | AHR |
| 600 | 72 | 59 | 111 | 80 |
| 300 | 51 | 41 | 78 | 55 |
| 200 | 42 | 43 | 66 | 46 |
| 100 | 32 | 25 | 50 | 35 |
| 6 | 16 | 12 | 37 | 20 |
| 3 | 15 | 11 | 36 | 19 |
| PV | 21 | 18 | 33 | 25 |
| YP | 30 | 23 | 45 | 30 |
| 10″ Gel | 14 | 11 | 46 | 27 |
| 10′ Gel | 15 | 12 | 46 | 32 |
| ES at 150 F. | 864 | 850 | 1519 | 1093 |
| HTHP at 250 F. (mL) | | 22 | | 16.6 |

### Example 4

An invert emulsion (70:30 O/W) wellbore fluid was formulated with a thinner (LDP-1090, available from Lamberti USA Inc. (Conshohocken, Pa.)) loaded onto a silica powder (described above) at 60% active (vol/wt), in accordance with the present disclosure. The fluid also included VG PLUS™ (an amine treated bentonite), SUREMUL™ PLUS (an amidoamine emulsifier), ECOTROL™ (an oil soluble polymeric fluid loss control agent), MI WATE (a 4.1 SG barite), EMI-1005 (a rheology modifier), all of which are available from MI SWACO (Houston, Tex.), and OCMA (kaolinite). The fluids are formulated (with and without dried thinner) as shown in Table 6 below. The rheological properties were measured on a Fann 35 viscometer at the temperatures indicated, as shown in Table 7 below, before heat rolling and after heat rolling for 16 hours at 150 F.

TABLE 6

| | Sample 5 | Sample 6 |
|---|---|---|
| Component | (blank) | (Dried Thinning agent) |
| Synthetic Base (g) | 140 | 140 |
| VG PLUS ™ (g) | 1 | 1 |
| Lime (g) | 3 | 3 |
| SUREMUL ™ PLUS (g) | 10 | 10 |
| ECOTROL ™ RD (g) | 0.5 | 0.5 |
| 25% CaCl₂ brine (g) | 102.5 | 102.5 |
| MI WATE ™ (g) | 263 | 263 |
| EMI-1005 (g) | 1 | 1 |
| Thinning agent (g) | — | 2 |
| OCMA (g) | 25 | 25 |
| Mud Wt, ppg | 13.0 | |

TABLE 7

| | Sample 5 (blank) | | | | | Sample 6 (Dried) | | | | |
|---|---|---|---|---|---|---|---|---|---|---|
| | BHR | | AHR | | | BHR | | AHR | | |
| | 70 F. | 150 F. | 40 F. | 100 F. | 150 F. | 70 F. | 150 F. | 40 F. | 100 F. | 150 F. |
| 600 | 141 | 69 | 212 | 87 | 75 | 68 | 27 | 160 | 64 | 35 |
| 300 | 85 | 44 | 129 | 52 | 50 | 35 | 14 | 84 | 32 | 19 |
| 200 | 63 | 35 | 97 | 40 | 40 | 25 | 10 | 57 | 21 | 12 |
| 100 | 39 | 24 | 62 | 27 | 30 | 13 | 6 | 29 | 11 | 6 |
| 6 | 12 | 12 | 20 | 12 | 17 | 1 | 1 | 2 | 1 | 1 |
| 3 | 11 | 11 | 18 | 11 | 16 | 1 | 1 | 1 | 1 | 1 |
| PV | 56 | 25 | 83 | 35 | 25 | 33 | 13 | 76 | 32 | 16 |
| YP | 29 | 19 | 46 | 17 | 25 | 2 | 1 | 8 | 0 | 3 |
| 10″ Gel | 20 | 17 | 24 | 18 | 23 | 1 | 1 | 2 | 1 | 1 |
| 10′ Gel | 27 | 25 | 34 | 23 | 31 | 1 | 1 | 2 | 1 | 1 |
| ES | | 441 | | | 721 | | 528 | | | 544 |
| HTHP 250 F. | | | | | 3 | | | | | 8.6 |

### Example 5

An invert emulsion (90:130 O/W) wellbore fluid was formulated with a dispersant (EMI-2034, available from M-I SWACO (Houston, Tex.)) loaded onto a silica powder (described above) at 50% active (vol/wt), in accordance with the present disclosure. The fluid also included VG SUPREME™ (organophilic clay), SUREMUL™ (an amidoamine surfactant), EMI-1012UF (an ultrafine barite), all of which are available from MI SWACO (Houston, Tex.). The fluids are formulated (with liquid and dried dispersant EMI-2034 and without dispersant) as shown in Table 8 below. The rheological properties were measured on a Fann 35 viscometer at 150 F, as shown in Table 9 below, before heat rolling and after heat rolling for 16 hours at 150 F.

TABLE 8

| | | Sample 8 | Sample 9 |
|---|---|---|---|
| | Sample 7 | (liquid | (Dried |
| Component | (blank) | EMI-2034) | EMI-2034) |
| Synthetic Base (g) | 61.5 | 61.5 | 61.5 |
| VG SUPREME ™ (g) | 0.5 | 0.5 | 0.5 |
| Lime (g) | 1.5 | 1.5 | 1.5 |
| SUREMUL ™ (g) | 9.5 | 9.5 | 9.5 |
| 25% CaCl₂ brine (g) | 11.65 | 11.65 | 11.65 |
| EMI-1012UF (g) | 325 | 325 | 325 |
| EMI-2034 (g) | 0 | 2 | 2 |
| Mud Wt, ppg | 19.49 | 19.34 | 19.34 |

TABLE 9

| | Sample 7 | | Sample 8 | | Sample 9 | |
|---|---|---|---|---|---|---|
| | (blank) | | (liquid EMI-2034) | | (Dried EMI-2034) | |
| | BHR | AHR | BHR | AHR | BHR | AHR |
| 600 | 113 | 99 | 93 | 79 | 111 | 91 |
| 300 | 70 | 59 | 50 | 42 | 62 | 48 |
| 200 | 53 | 30 | 21 | 16 | 25 | 19 |
| 100 | 35 | 30 | 21 | 16 | 25 | 19 |
| 6 | 12 | 10 | 4 | 3 | 6 | 3 |
| 3 | 10 | 8 | 4 | 2 | 5 | 2 |
| PV | 43 | 40 | 43 | 37 | 49 | 43 |
| YP | 27 | 19 | 7 | 5 | 13 | 5 |
| 10″ Gel | 11 | 8 | 5 | 3 | 6 | 3 |
| 10′ Gel | 11 | 10 | 6 | 4 | 7 | 5 |
| ES | 812 | 880 | 861 | 921 | 800 | 780 |

### Example 6

A 9 ppg invert emulsion wellbore fluid was formulated with a thinner (LDP-1090, available from Lamberti USA Inc. (Conshohocken, Pa.)) loaded onto a silica powder (described above) at 60% active, in accordance with the present disclosure. The fluid also included VG PLUS™ (an amine treated bentonite), ACTIMUL™ RD (a dry emulsifier), all of which are available from MI SWACO (Houston, Tex.), and OCMA (kaolinite) and low sulfur diesel. The fluids (with and without OCMA, to simulate the effect of drill cuttings on the fluid) are formulated as shown in Table 10 below. The rheological properties were measured on a Fann 35 viscometer at 150 F, as shown in Table 11 below, before heat rolling and after heat rolling for 16 hours at 150 F.

TABLE 10

| Component | Sample 10 (base) | Sample 11 (OCMA) |
|---|---|---|
| Low S diesel (g) | 188.6 | 188.6 |
| VG PLUS ™ (g) | 7 | 7 |
| Lime (g) | 4 | 4 |
| ACTIMUL RD (g) | 4 | 4 |
| 25% CaCl₂ brine (g) | 128.1 | 128.1 |
| barite (g) | 45.6 | 45.6 |
| LDP-1090 (g) | 1 | 1 |
| OCMA (g) | — | 35 |

TABLE 11

| | |
|---|---|
| Sample 10 (base) | Sample 11 (OCMA) |

| | BHR | AHR | BHR | AHR |
|---|---|---|---|---|
| 600 | 33 | 41 | 40 | 53 |
| 300 | 19 | 27 | 25 | 36 |
| 200 | 14 | 22 | 18 | 29 |
| 100 | 9 | 16 | 13 | 21 |
| 6 | 3 | 8 | 7 | 13 |
| 3 | 3 | 8 | 6 | 12 |
| PV | 14 | 14 | 15 | 17 |
| YP | 5 | 13 | 10 | 19 |
| 10″ Gel | 5 | 19 | 9 | 13 |
| 10′ Gel | 7 | 11 | 11 | 15 |
| ES | 483 | 631 | 190 | 265 |
| HTHP at 250 F. | | 3.2 | | 2.6 |

### Example 7

A 13 ppg, 80:20 O/W invert emulsion wellbore fluid was formulated with a wetting agent (VERSAWET™, available from M-I SWACO (Houston, Tex.)) loaded onto a silica powder (described above) at 60% active, in accordance with the present disclosure. The fluid also included VG PLUS™ (an amine treated bentonite), ACTIMUL™ RD (a dried emulsifier), all of which are available from MI SWACO (Houston, Tex.), and OCMA (kaolinite) and low sulfur diesel. The fluids (with and without OCMA, to simulate the effect of drill cuttings on the fluid) are formulated as shown in Table 12 below. The rheological properties were measured on a Fann 35 viscometer at 150 F, as shown in Table 13 below, before heat rolling and after heat rolling for 16 hours at 250 F.

TABLE 12

| | | Sample 13 (OCMA |
|---|---|---|
| Component | Sample 12 (base) | contaminated) |
| Low S Diesel (g) | 177.7 | 177.7 |
| VG PLUS ™ (g) | 6 | 6 |
| Lime (g) | 8 | 8 |
| ACTIMUL RD (g) | 5 | 5 |
| 25% CaCl₂ brine (g) | 70. | 70.5 |
| barite (g) | 278 | 278 |
| Dried VERSAWET (g) | 1 | 1 |
| OCMA (g) | — | 30 |

TABLE 13

| | Sample 12 (base) | | Sample 13 (OCMA contaminated) | |
|---|---|---|---|---|
| | BHR | AHR | BHR | AHR |
| 600 | 44 | 54 | 53 | 54 |
| 300 | 28 | 35 | 36 | 31 |
| 200 | 20 | 27 | 28 | 22 |
| 100 | 13 | 19 | 20 | 13 |
| 6 | 6 | 10 | 11 | 5 |
| 3 | 5 | 9 | 10 | 4 |
| PV | 16 | 19 | 17 | 23 |
| YP | 12 | 16 | 19 | 8 |
| 10″ Gel | 7 | 13 | 14 | 9 |
| 10′ Gel | 12 | 20 | 20 | 27 |
| ES | 737 | 989 | 387 | 379 |
| HTHP at 250 F. | | 4.4 | | 8.4 |

### Example 8

A 16 ppg, 85:15 O/W invert emulsion wellbore fluid was formulated with a wetting agent (VERSAWET™, available from M-I SWACO (Houston, Tex.)) loaded onto a silica powder (described above) at 60% active, in accordance with the present disclosure. The fluid also included VERSAGEL HT™ (hectorite clay viscosifier), ACTIMUL™ RD (a dried emulsifier), VERSATROL (gilsonite), all of which are available from MI SWACO (Houston, Tex.), and OCMA (kaolinite) and diesel. The fluids (with differing amounts of ACTIMUL™ RD) are formulated as shown in Table 14 below. The rheological properties were measured on a Fann 35 viscometer at 150 F, as shown in Table 15 below, before heat rolling and after heat rolling for 16 hours at 300 F.

TABLE 14

| Component | Sample 14 | Sample 15 |
|---|---|---|
| Diesel (g) | 158.2 | 159.05 |
| VERSAGEL ™ HT (g) | 4 | 4 |
| Lime (g) | 6 | 6 |
| ACTIMUL RD (g) | 7 | 5 |
| Dried VERSAWET (g) | 1 | 1 |
| 25% CaCl₂ brine (g) | 44.4 | 44.4 |
| barite (g) | 448.5 | 448.6 |
| VERSATROL ™ (g) | 4 | 4 |
| OCMA (g) | — | — |

TABLE 15

| | |
|---|---|
| Sample 14 | Sample 15 |

| | BHR | AHR | BHR | AHR |
|---|---|---|---|---|
| 600 | 95 | 106 | 55 | 67 |
| 300 | 62 | 66 | 31 | 36 |
| 200 | 49 | 50 | 24 | 26 |
| 100 | 36 | 34 | 17 | 16 |
| 6 | 20 | 18 | 8 | 6 |
| 3 | 20 | 17 | 7 | 6 |
| PV | 33 | 40 | 24 | 31 |
| YP | 29 | 26 | 7 | 5 |
| 10″ Gel | 25 | 38 | 10 | 15 |
| 10′ Gel | 32 | 43 | 14 | 25 |
| ES | 981 | 1331 | 768 | 984 |
| HTHP at 250 F. | | 1.2 | | 1.4 |

### Example 9

A 13 ppg, 75:25 O/W invert emulsion wellbore fluid was formulated with a wetting agent (VERSAWET™, available from M-I SWACO (Houston, Tex.)) loaded onto a silica powder (described above) at 60% active, in accordance with the present disclosure. The fluid also included VG PLUS™ (an amine treated bentonite), and ACTIMUL™ RD (a dried emulsifier), which are available from MI SWACO (Houston, Tex.), and OCMA (kaolinite) and Biobase 300. The fluids (with and without OCMA to simulate the effects of drill cuttings) are formulated as shown in Table 16 below. The rheological properties were measured on a Fann 35 viscometer at 150 F, as shown in Table 17 below, before heat rolling and after heat rolling for 16 hours at 250 F.

TABLE 16

| Component | Sample 16 | Sample 17 |
|---|---|---|
| Biobase 300 (g) | 155 | 155 |
| VG PLUS (g) | 8 | 8 |
| Lime (g) | 3 | 3 |
| ACTIMUL RD (g) | 5 | 5 |
| Dried EMI-3071 (g) | 1 | 1 |
| 25% CaCl₂ brine (g) | 88 | 88 |
| barite (g) | 286.5 | 286.5 |
| OCMA (g) | — | 25 |

TABLE 17

| | |
|---|---|
| Sample 16 | Sample 17 |

| | BHR | AHR | BHR | AHR |
|---|---|---|---|---|
| 600 | 50 | 61 | 55 | 64 |
| 300 | 33 | 41 | 38 | 43 |
| 200 | 24 | 32 | 30 | 33 |
| 100 | 17 | 23 | 22 | 24 |
| 6 | 8 | 12 | 12 | 12 |
| 3 | 8 | 11 | 11 | 11 |
| PV | 17 | 20 | 17 | 21 |
| YP | 16 | 21 | 21 | 22 |
| 10″ Gel | 11 | 15 | 16 | 17 |
| 10′ Gel | 17 | 23 | 23 | 27 |
| ES | 910 | 1023 | 412 | 767 |
| HTHP at 250 F. | | 6.2 | | 8.6 |

### Example 10

A 13.5 ppg, 75:25 O/W invert emulsion wellbore fluid was formulated with a wetting agent (VERSAWET™, available from M-I SWACO (Houston, Tex.)) loaded onto a silica powder (described above) at 60% active, in accordance with the present disclosure. The fluid also included VG PLUS™ (an amine treated bentonite), ACTIMUL™ RD (a dried emulsifier), and MEGATROL™ (filtration control additive), all of which are available from MI SWACO (Houston, Tex.), and OCMA (kaolinite) and Escaid 110 base fluid. The fluids (with and without OCMA to simulate the effects of drill cuttings) are formulated as shown in Table 18 below. The rheological properties were measured on a Fann 35 viscometer at 150 F, as shown in Table 19 below, before heat rolling and after heat rolling for 16 hours at 250 F.

TABLE 18

| Component | Sample 18 | Sample 19 |
|---|---|---|
| Biobase 300 (g) | 153.2 | 153.2 |
| VG PLUS (g) | 8 | 8 |
| Lime (g) | 6 | 6 |
| ACTIMUL RD (g) | 7 | 7 |
| Dried EMI-3071 (g) | 1 | 1 |
| 25% CaCl₂ brine (g) | 85 | 85 |
| barite (g) | 306.5 | 306.5 |
| MEGATROL | 0.5 | 0.5 |
| OCMA (g) | — | 25 |

TABLE 19

| | |
|---|---|
| Sample 18 | Sample 19 |

| | BHR | AHR | BHR | AHR |
|---|---|---|---|---|
| 600 | 63 | 93 | 80 | 110 |
| 300 | 41 | 67 | 54 | 72 |
| 200 | 32 | 55 | 43 | 57 |
| 100 | 23 | 43 | 32 | 42 |
| 6 | 11 | 26 | 17 | 23 |
| 3 | 10 | 25 | 16 | 22 |
| PV | 22 | 26 | 26 | 38 |
| YP | 19 | 41 | 28 | 34 |
| 10″ Gel | 13 | 24 | 19 | 29 |
| 10′ Gel | 20 | 28 | 27 | 33 |
| ES | 702 | 900 | 355 | 619 |
| HTHP at 250 F. | | 3 | | 2.8 |

### Example 11

A 13 ppg, 80:20 O/W invert emulsion wellbore fluid was formulated with a wetting agent (VERSAWET™, available from M-I SWACO (Houston, Tex.)) loaded onto a silica powder (described above) at 60% active, in accordance with the present disclosure. The fluid also included VG PLUS™ (an amine treated bentonite), ACTIMUL™ RD (a dried emulsifier), all of which are available from MI SWACO (Houston, Tex.), and low sulfur diesel. A base fluid is formulated as shown in Table 20 below, without any wetting agent, and additional fluids were also formulated with amounts of dried VERSAWET™ (1 ppb, 2 ppb, 3 ppb, 4 ppb, and 10 ppb) added thereto. The rheological properties were measured on a Fann 35 viscometer at 150 F, as shown in Table 21a and 21b below, before heat rolling and after heat rolling for 16 hours at 250 F.

TABLE 20

| Component | Sample 20 (base) |
|---|---|
| Low S Diesel (g) | 177.7 |
| VG PLUS ™ (g) | 6 |
| Lime (g) | 8 |
| ACTIMUL RD (g) | 5 |
| 25% CaCl₂ brine (g) | 70. |
| barite (g) | 278 |
| Dried VERSAWET (g) | 1 |
| OCMA (g) | — |

TABLE 21a

| | Sample 20 | | Sample 21 | | Sample 22 | |
|---|---|---|---|---|---|---|
| | (0 ppb WA) | | (1 ppb WA) | | (2 ppb WA) | |
| | BHR | AHR | BHR | AHR | BHR | AHR |
| 600 | 58 | 69 | 59 | 57 | 60 | 55 |
| 300 | 37 | 41 | 37 | 31 | 36 | 28 |
| 200 | 30 | 32 | 30 | 23 | 29 | 20 |
| 100 | 23 | 25 | 23 | 15 | 21 | 11 |
| 6 | 13 | 13 | 13 | 6 | 12 | 4 |
| 3 | 12 | 12 | 12 | 6 | 11 | 3 |
| PV | 21 | 28 | 22 | 26 | 24 | 27 |
| YP | 16 | 13 | 15 | 5 | 12 | 1 |
| 10″ Gel | 13 | 15 | 14 | 13 | 13 | 9 |
| 10′ Gel | 17 | 25 | 18 | 23 | 20 | 15 |
| ES | 601 | 914 | 608 | 708 | 576 | 465 |
| HPHT at 250 F. | | 13.6 | | 8.6 | | 6 |

TABLE 21b

| | Sample 23 | | Sample 24 | | Sample 25 | |
|---|---|---|---|---|---|---|
| | (3 ppb WA) | | (4 ppb WA) | | (10 ppb WA) | |
| | BHR | AHR | BHR | AHR | BHR | AHR |
| 600 | 60 | 49 | 58 | 47 | 70 | 52 |
| 300 | 34 | 24 | 36 | 25 | 41 | 26 |
| 200 | 27 | 17 | 28 | 17 | 33 | 18 |
| 100 | 19 | 9 | 20 | 10 | 23 | 11 |
| 6 | 10 | 3 | 11 | 3 | 10 | 3 |
| 3 | 10 | 2 | 10 | 3 | 9 | 3 |
| PV | 26 | 25 | 22 | 22 | 29 | 26 |
| YP | 8 | −1 | 14 | 3 | 12 | 0 |
| 10″ Gel | 14 | 6 | 13 | 6 | 12 | 5 |
| 10′ Gel | 18 | 11 | 17 | 10 | 17 | 8 |
| ES | 539 | 395 | 510 | 376 | 395 | 309 |
| HPHT at 250 F. | | 0 | | 1 | | 0 |

### Example 12

The fluid formulation from Sample 20 was used as a base fluid for the addition of 6 ppb liquid VERSAWET™, 4 ppb silica, and 6 ppb liquid VERSAWET™ with 4 ppb silica so that the rheological properties could be compared to Sample 25 (10 ppb dried VERSAWET™ at 60% active). The rheological properties were measured on a Fann 35 viscometer at 150 F, as shown in Table 22 below, before heat rolling and after heat rolling for 16 hours at 250 F.

| | Sample 25 (10 | | Sample 26 (6 ppb | | | | Sample 28 (6 ppb | |
|---|---|---|---|---|---|---|---|---|
| | ppb dried | | liquid | | Sample 27 (4 ppb | | liquid VERSAWET + | |
| | VERSAWET ™) | | VERSAWET ™) | | silica) | | 4 ppb silica) | |
| | BHR | AHR | BHR | AHR | BHR | AHR | BHR | AHR |
| 600 | 70 | 52 | 74 | 51 | 57 | 81 | 103 | 58 |
| 300 | 41 | 26 | 44 | 27 | 37 | 54 | 63 | 31 |
| 200 | 33 | 18 | 33 | 18 | 30 | 43 | 49 | 20 |
| 100 | 23 | 11 | 22 | 11 | 22 | 32 | 33 | 12 |
| 6 | 10 | 3 | 7 | 2 | 13 | 18 | 11 | 3 |
| 3 | 9 | 3 | 5 | 2 | 12 | 18 | 19 | 2 |
| PV | 29 | 26 | 30 | 24 | 20 | 27 | 40 | 27 |
| YP | 12 | 0 | 14 | 3 | 17 | 27 | 23 | 4 |
| 10″ Gel | 12 | 5 | 7 | 5 | 13 | 19 | 13 | 5 |
| 10′ Gel | 17 | 8 | 12 | 7 | 17 | 26 | 18 | 8 |
| ES | 395 | 309 | 488 | 362 | 377 | 558 | 341 | 276 |
| HPHT | | 0 | | 34.5 | | 16 | | 26 |
| at 250 F. | | | | | | | | |

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed:

1. A method, comprising:
a. adding a dry carrier powder loaded with a liquid additive into a wellbore fluid, thereby releasing at least a portion of the liquid additive into the wellbore fluid; and
b. pumping the wellbore fluid with the liquid additive therein into a wellbore.

2. The method of claim 1, further comprising: mixing the dry carrier powder with the liquid additive to load the liquid additive into dry carrier powder.

3. The method of claim 1, further comprising: removing at least a portion of the dry carrier powder from the wellbore fluid after the release of the liquid additive into the wellbore fluid.

4. The method of claim 3, wherein the pumping occurs after the removing.

5. The method of claim 3, wherein the removing occurs after the pumping.

6. The method of claim 5, further comprising: repumping the wellbore fluid into the wellbore after removing.

7. The method of claim 1, wherein the dry carrier comprises silica powder.

8. The method of claim 1, wherein the liquid additive is selected from the group consisting of wetting agents, thinners, rheology modifiers, emulsifiers, surfactants, dispersants, interfacial tension reducers, pH buffers, mutual solvents, lubricants, defoamers, and cleaning agents.

9. The method of claim 8, wherein the liquid additive is selected from the group consisting of wetting agents, thinners, and rheology modifiers.

10. The method of claim 1, wherein the liquid additive in the dry carrier powder is added in an amount up to 8 pounds per barrel.

11. The method of claim 1, wherein the dry carrier powder loaded with the liquid additive is flowable.

12. The method of claim 1, wherein the dry carrier powder has a d₅₀ ranging from about 50 to 250 microns.

13. The method of claim 12, wherein the dry carrier powder has a d₅₀ ranging from about 100 to 150 microns.

14. A method, comprising:
a. circulating a wellbore fluid comprising a base fluid and a dry carrier loaded with a liquid additive through a wellbore while drilling;
b. collecting the circulated wellbore fluid at the surface, the circulated wellbore fluid comprising the base fluid, liquid additive released into the base fluid from the dry carrier, and the dry carrier ; and
c. removing at least a portion of the dry carrier from the circulated wellbore fluid to form a separated wellbore fluid comprising the base fluid and the liquid additive released into the base fluid; and
d. re-circulating the separated wellbore fluid through the wellbore.

15. The method of claim 14, wherein the removing comprises screening the separated wellbore fluid through a vibratory separator.

16. The method of claim 14, The method of claim 1, wherein the dry carrier comprises silica powder.

17. The method of claim 8, wherein the liquid additive is selected from the group consisting of wetting agents, thinners, and rheology modifiers.

18. The method of claim 1, wherein the liquid additive in the dry carrier powder is added in an amount up to 8 pounds per barrel.

19. The method of claim 1, wherein the dry carrier powder has a d₅₀ ranging from about 50 to 250 microns.

20. The method of claim 12, wherein the dry carrier powder has a d₅₀ ranging from about 100 to 150 microns.
